(19) United States
(12) Patent Application Publication
(10) Pub. No.: US 2018/0284894 A1
(43) Pub. Date: Oct. 4, 2018

(54) DIRECTIONAL HAPTICS FOR IMMERSIVE VIRTUAL REALITY

(71) Applicant: Intel Corporation, Santa Clara, CA (US)

(72) Inventors: Aditya K. Raut, Bangalore (IN); Sanjay R. Aghara, Bangalore (IN)

(21) Appl. No.: 15/905,386

(22) Filed: Feb. 26, 2018

(30) Foreign Application Priority Data
Mar. 31, 2017 (IN) 201741011603

(51) Int. Cl. G06F 3/01; H04S 7/00; H04S 3/00

(52) U.S. Cl. CPC G06F 3/016; G06F 3/012; H04S 2400/13; H04S 3/008; H04S 7/303

(57) ABSTRACT

Systems and techniques for directional haptics for immersive virtual reality are described herein. A first audio signal may be received on a first audio channel and a second audio signal may be received on a second audio channel. A set of haptic actuators may be identified. A first subset of the set of haptic actuators may be grouped into a first audio channel group corresponding to the first audio channel and a second subset of the set of haptic actuators may be grouped into a second audio channel group corresponding to the second audio channel. The first audio signal may be transmitted to the first audio channel group and the second audio signal may be transmitted to the second audio channel group.

### CLAIM OF PRIORITY

This patent application claims the benefit of priority to India Patent Application No. 201741011603, filed Mar. 31, 2017, which claims the benefit of priority to India Provisional Patent Application No. 201741011603, titled “DIRECTIONAL HAPTICS FOR IMMERSIVE VIRTUAL REALITY” and filed on Mar. 31, 2017, the entireties of which are hereby incorporated by reference herein.

### TECHNICAL FIELD

Embodiments described herein generally relate to virtual reality and, in some embodiments, more specifically to directional haptics for immersive virtual reality.

### BACKGROUND

Virtual reality involves computer-generated simulations of three-dimensional images or environments allowing physical interaction. A user in a virtual reality simulation may be able to interact with the environment similarly to the way the user may interact with the physical world. The user may receive feedback from components of the virtual reality system to simulate sensations (e.g., sights, sounds, haptics, etc.) experienced in the physical world.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a diagram of an example of an environment for directional haptics for immersive virtual reality, according to an embodiment.

FIG. 2 is a block diagram of an example of a system for directional haptics for immersive virtual reality, according to an embodiment.

FIG. 3A illustrates an example of a front view of a device for directional haptics for immersive virtual reality, according to an embodiment.

FIG. 3B illustrates an example of a rear view of a device for directional haptics for immersive virtual reality, according to an embodiment.

FIG. 4 illustrates an example of haptic device placement in a fixed group configuration for directional haptics for immersive virtual reality, according to an embodiment.

FIG. 5 illustrates and example of directional inputs used in grouping haptic actuators for directional haptics for immersive virtual reality, according to an embodiment.

FIG. 6 illustrates an example of haptic device placement in a dynamic group configuration for directional haptics for immersive virtual reality, according to an embodiment.

FIG. 7 illustrates a flow diagram of an example of a method for directional haptics for immersive virtual reality, according to an embodiment.

FIG. 8 is a block diagram illustrating an example of a machine upon which one or more embodiments may be implemented.

### DETAILED DESCRIPTION

Haptics may become an important feature for immersive gaming experience in areas such as, for example, PC gaming, virtual reality (VR), augmented reality (AR), mixed reality (MR), etc. A wearable haptics vest may include haptic actuators (e.g., linear resonant actuators (LRA), eccentric rotating mass (ERM), piezo, voice-coil, etc.) that may take audio or pulse-width modulation (PWM) as an input signal and may generate vibrations based on amplitude or frequency. The audio signal, which may be input to a haptic actuator, may be based on a head orientation of a user and may be generated by a computer. The haptics vest orientation may differ from the head orientation of the user. Using audio that is generated based on head orientation of the user may result in the generation of incorrect directional haptics feedback. Generating precise directional haptics feedback may enhance a gaming experience of the user by providing feedback that more closely resembles the real world.

Grouping the haptic actuators based on an orientation of a user's head (e.g., using sensors in a head mounted display, etc.), body (e.g., using sensors in a wearable device including the haptic actuators, etc.), and/or a character object of the user (e.g., based on the position of the character object in the game environment, etc.) may provide a more realistic virtual reality experience. By grouping the haptic actuators the user may be presented with haptic feedback based on the position of the head and body with respect to an action in the virtual world. For example, the user may be looking at an explosion with the body turned away from the explosion and the haptic actuators in a vest worn by the user may be grouped based on the orientation of the vest and/or the head of the user to provide directionally accurate haptics feedback.

The output to the haptic actuators may be weighted to provide proportional feedback based on the distance of a haptic actuator from the position of an effect in the virtual world. The haptic actuators may be grouped based on relative position to a centerline and/or rotational plane (e.g., of the wearable device, headset, player character, etc.) and the amplitude of the output to a member of each group may be adjusted based on the distance of the member from the centerline. For example, the user's left shoulder may be furthest from a centerline in the direction of an explosion and the amplitude of the signal transmitted to a haptic actuator may be decreased. Grouping and weighing the haptic actuators may provide more accurate haptic feedback because the audio signals used to trigger the haptic actuators may be routed and adjusted based on the position of each individual sensor. Thus, the user may experience a virtual world more closely resembling the real world.

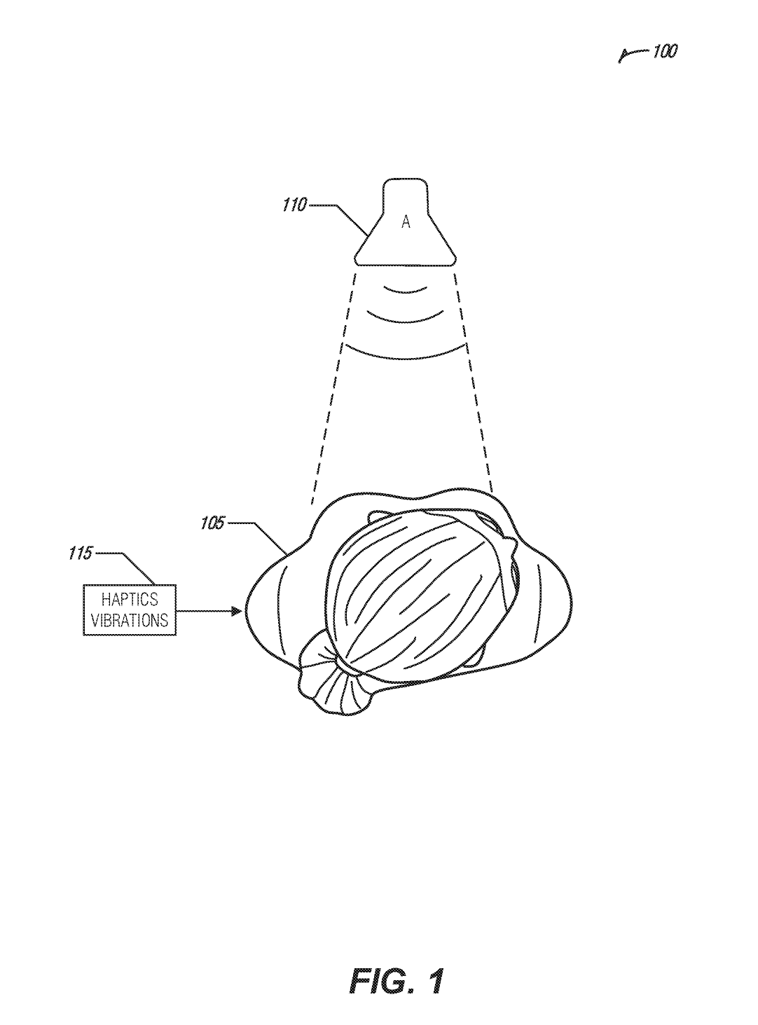

FIG. 1 is a diagram of an example of an environment 100 for directional haptics for immersive virtual reality, according to an embodiment. The environment 100 may include a user 105, an audio source A 110, and haptics vibrations 115. As noted above, in a naïve immersive virtual reality implementations, a disconnect may occur between haptic sensations on the user's body and visual observations of the user 105. For example, the user 105 may be wearing a VR head mounted display (HMD) and headphone and may be looking to her right while a vest and/or torso facing front facing. Audio may be generated (e.g., an explosion in game, etc.) from the audio source A 110 within a virtual world in front of the user 105. Because the user 105 is looking to her right, naïve spatial audio is generated with respect to the head position, causing haptics output to the left side of the user 105. By relying on the head orientation to infer the user's body (e.g., a worn haptics vest), the naïve implementation fails to provide the user 105 with a realistic experience.

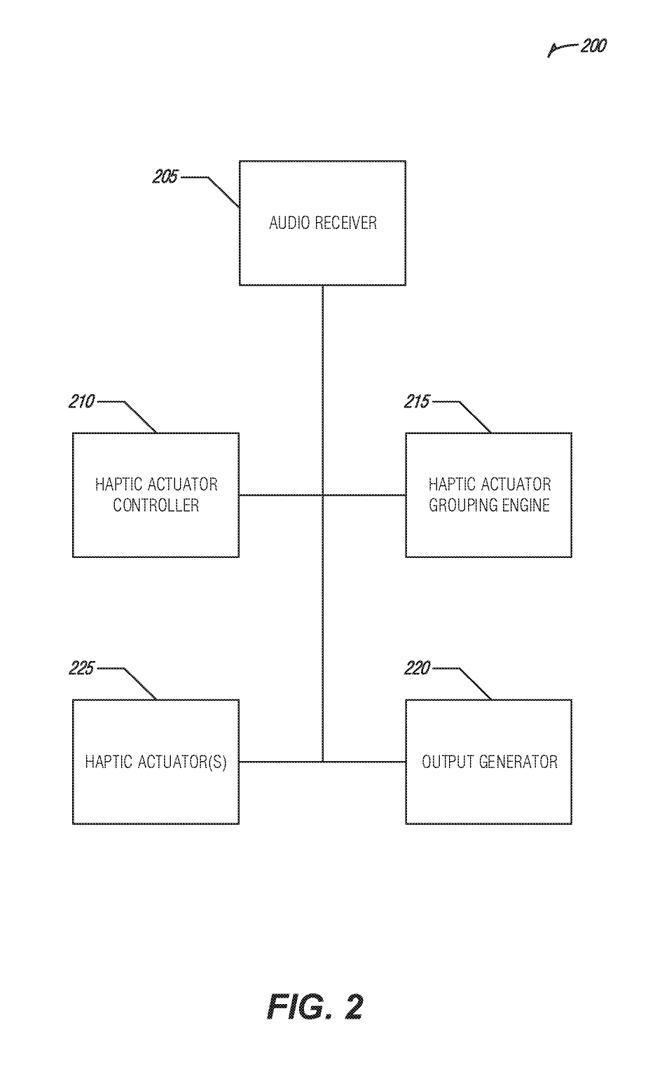

FIG. 2 is a block diagram of an example of a system 200 for directional haptics for immersive virtual reality, according to an embodiment. The system 200 may include a variety of components such as an audio receiver 205, a haptic actuator controller 210, a haptic actuator grouping engine 215, an output generator 220, and haptic actuator(s) 225.

The audio receiver 205 may receive a variety of audio signals (e.g., audio from a game, virtual world, etc.) as inputs. The audio may be received over one or more channels. For example, six audio channels may be received in a virtual world using 5.1 surround sound. The audio receiver 205 may receive a first audio signal on a first audio channel and a second audio signal on a second audio channel. For example, a right audio signal may be received on a right audio channel and a left audio signal may be received on a left audio channel. While the examples provided may describe grouping the haptic actuator(s) 225 into two groups, it will be understood that the haptic actuator(s) 225 may be grouped into any appropriate number of groups corresponding to a number of audio channels in use in the environment using the techniques discussed herein. While examples involving virtual reality (VR) may be discussed, it will be readily understood that the described techniques may be used in other environments in which haptic actuators may be used such as, by way of example and not limitation, PC gaming, augmented reality (AR), mixed reality (MR), etc.

The haptic actuator controller 210 may control the haptic actuator(s) 225. The haptic actuator controller 210 may identify a set of haptic actuators (e.g., the haptic actuator(s) 225). The haptic actuator(s) 225 may be included in a wearable device (e.g., a vest, smart shirt, etc.). The haptic actuator(s) 225 may be distributed at varying locations in and/or on the wearable device to provide haptic feedback to a user. For example, a vest may include a haptic actuator on each shoulder, each side of the front, each side of the back, etc. The haptic actuator(s) 225 may take audio signals, pulse-width modulation (PWM) signals, or other signals as an input signal and may generate vibrations based on amplitude or frequency of the signal. The haptic actuator(s) 225 may be driven from an audio signal, pulse-width modulation, or other compatible electrical signal.

The haptic actuator grouping engine 215 may group the haptic actuator(s) 225 into logical groups. The haptic actuator grouping engine may group a first subset of the set of haptic actuators into a first audio channel group corresponding to the first audio channel and a second subset of the set of haptic actuators into a second audio channel group corresponding to the second audio channel. In an example, the haptic actuator grouping engine 215 may work in conjunction with the audio receiver 205 to generate spatial audio.

The haptic actuator grouping engine 215 may obtain a source audio signal (e.g., from the audio receiver 205). The haptic actuator grouping engine 215 may calculate an orientation of a headset using a sensor. For example, the user may be wearing a head mounted display for viewing a virtual reality environment and sensors such as, for example, a gyroscope, accelerometer, magnetometer, etc. may be used to determine the orientation of the head mounted display which may approximate the orientation of the user's head. Spatial audio may be generated including the first audio signal and the second audio signal based on the orientation of the headset. For example, a left audio signal may be generated for the left side of the user's head and a right audio signal may be generated for the right side of the user's head.

In an example, a plane of rotation of the headset may be identified around a first axis and a second axis. The grouping of the first subset of the set of haptic actuators into the first audio channel group corresponding to the first audio channel and the second subset of the set of haptic actuators into the second audio channel group corresponding to the second audio channel may be based on determining that the first subset of haptic actuators is on a first side of the plane of rotation and the second subset of haptic actuators is on a second side of the plane of rotation. For example, the user may be looking towards an explosion and a YZ plane may be identified for the head mounted display and members of the haptic actuator(s) 225 falling on the left side of the YZ plane may be placed in a left group and members of the haptic actuator(s) 225 falling on the right side of the YZ plane may be placed in a right group. A variety of additional planes may be identified using rotation around various combinations of the XYZ axes such as, for example, an XZ plane for grouping the haptic actuator(s) 225 into a variety of groups (e.g., N groups) vertically, horizontally, diagonally, etc. In an example, a plane of rotation of the headset around a first axis, a second axis, and a third axis may be identified.

In an example, the haptic actuator grouping engine 215 may calculate a distance from the plane of rotation for a haptic actuator of the set of haptic actuators. An amplitude of an audio signal to be transmitted to the haptic actuator may be altered based on the distance from the plane of rotation. For example, an output signal to a member of the haptic actuator(s) 225 that is farther away from the plane of rotation may have its amplitude decreased while an output signal to a member of the haptic actuator(s) 225 that is closer to the plane of rotation may have its amplitude increased.

In an example, a first directional weighting and a second directional weighting may be determined for the haptic actuator using the distance from the plane of rotation. A first directional amplitude may be multiplied by the first directional weighting to create a first direction adjusted amplitude and a second directional amplitude may be multiplied by the second directional weighting to create a second direction adjusted amplitude. The altered audio signal may comprise the sum of the first direction adjusted amplitude and the second direction adjusted amplitude. For example, the equation S(t)=Wl× Al(t)+Wr× Ar(t) may be used to determine a signal to be transmitted to a member of the haptics actuator(s) 225 where Al and Ar are left and right channel signals respectively and Wl and Wr are the left and right weightings respectively.

The haptic actuator grouping engine 215 may obtain a source audio signal (e.g., from the audio receiver 205). The haptic actuator grouping engine 215 may calculate an orientation of a wearable device including the haptic actuator(s) 225 using a sensor. For example, the user may be wearing a vest for receiving haptic feedback in the virtual reality environment and sensors such as, for example, a gyroscope, accelerometer, magnetometer, etc. may be used to determine the orientation of the vest which may approximate the orientation of the user's body. In an example, the haptic actuator grouping engine 215 may calculate an orientation of a player character in an electronic game (e.g., using data collected from a game engine, etc.). Spatial audio may be generated including the first audio signal and the second audio signal based on the orientation of the wearable device including the haptic actuator(s) 225. For example, a left audio signal may be generated for the left side of the user's body and a right audio signal may be generated for the right side of the user's body. In an example, spatial audio may be generated including the first audio signal and the second audio signal based on the orientation of the player character in the electronic game. For example, a left audio signal may be generated for the left side of the user's body corresponding to a left side of the user's game character and a right audio signal may be generated for the right side of the user's body corresponding to a right side of the user's game character.

In an example, a centerline of the wearable device including the haptic actuator(s) 225 may be identified. The grouping of the first subset of the set of haptic actuators into the first audio channel group corresponding to the first audio channel and the second subset of the set of haptic actuators into the second audio channel group corresponding to the second audio channel may use the centerline of the wearable device including the haptic actuator(s) 225. For example, the user may be facing towards an explosion and a centerline may be identified for the vest and members of the haptic actuator(s) 225 falling on the left side of the centerline may be placed in a left group and members of the haptic actuator(s) 225 falling on the right side of the centerline may be placed in a right group.

In an example, the haptic actuator grouping engine 215 may calculate a distance from the centerline for a haptic actuator of the set of haptic actuators. An amplitude of an audio signal to be transmitted to the haptic actuator may be altered based on the distance from the centerline. For example, an output signal to a member of the haptic actuator(s) 225 that is farther away from the centerline may have its amplitude decreased while an output signal to a member of the haptic actuator(s) 225 that is closer to the centerline may have its amplitude increased.

In an example, a first directional weighting and a second directional weighting may be determined for the haptic actuator using the distance from the centerline. A first directional amplitude may be multiplied by the first directional weighting to create a first direction adjusted amplitude and a second directional amplitude may be multiplied by the second directional weighting to create a second direction adjusted amplitude. The altered audio signal may comprise the sum of the first direction adjusted amplitude and the second direction adjusted amplitude. For example, the equation S(t)=Wl×Al(t)+Wr×Ar(t) may be used to determine a signal to be transmitted to a member of the haptics actuator(s) 225 where Al and Ar are left and right channel signals respectively and Wl and Wr are the left and right weightings respectively.

The haptic actuator grouping engine 215 may work in conjunction with the output generator 220 and the haptic actuator controller 210 to transmit the altered audio signal to the haptic actuator. In an example, the spatial audio including the first audio signal and the second audio signal may be transmitted to the headset. The first audio signal may be transmit to a first speaker included with the headset and the second audio signal may be transmitted to a second speaker included with the headset.

The output generator 220 may generate output such as audio signals and may work in conjunction with the haptic actuator controller 210 to transmit the signals to the haptic actuator(s) 225. The output generator 220 in conjunction with the haptic actuator controller may transmit the first audio signal to the first audio channel group and the second audio signal to the second audio channel group. In an example, the output generator may obtain a low frequency effect signal (e.g., using the audio receiver 205) and the low frequency effect signal may be transmitted to the first audio channel group and the second audio channel group (e.g., using the haptic actuator controller 210). In an example, the first audio signal and the second audio signal may be transmitted via a wireless network (e.g., Wi-Fi, shortwave radio, nearfield communication, etc.). In an example, the first audio signal and the second audio signal may be transmitted via a wired network (e.g., Ethernet, shared bus, etc.). In an example, the first audio signal and the second audio signal may be converted to another format (e.g., pulse-width modulation, etc.) for transmission to respective haptic actuator(s) 225.

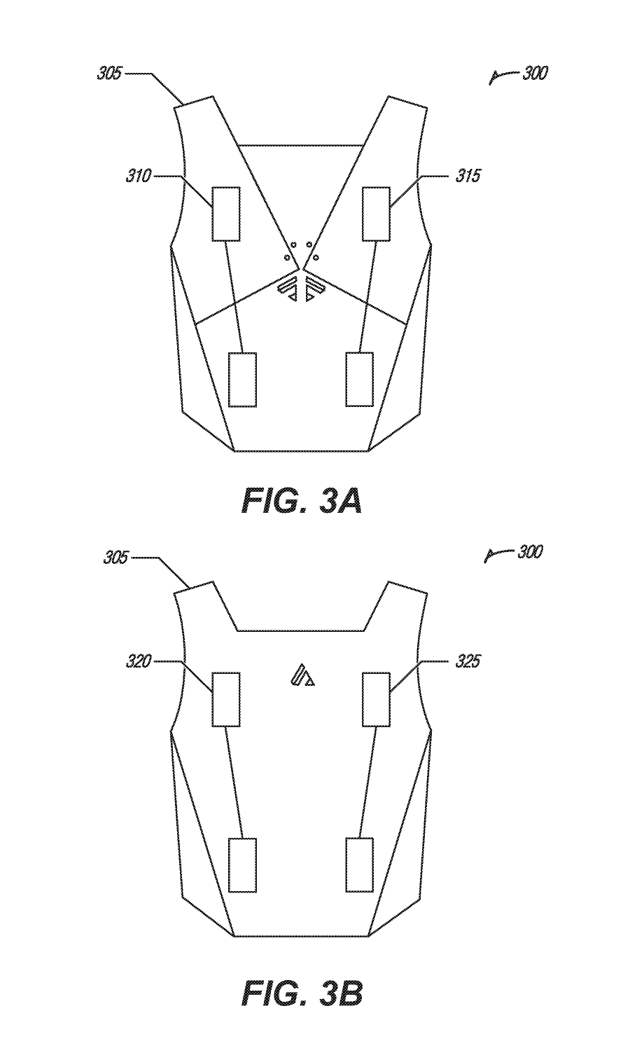

FIG. 3A illustrates an example of a front view of a device 300 for directional haptics for immersive virtual reality, according to an embodiment. The device 300 may be used to implement the functionality as described in FIG. 2.

The front of the device 300 may include a vest 305 including front right audio and low-frequency effects (LFE) device 310, and front left audio and LFE device 315. FIG. 3B illustrates an example of a rear view of the device 300 for directional haptics for immersive virtual reality, according to an embodiment. The rear of the device 300 may include the vest 305 including back left audio and LFE device 320, and back right audio and LFE device 325. In an example, the front right audio and LFE device 310, the front left audio and LFE device 315, the back left audio and LFE device 320, and the back right audio and LFE device 325 may be mapped to six channel surround sound (e.g., 5.1 surround sound audio). In an example, the device 300 may include a variety of audio and LFE devices configured to additional audio channels to provide improved directional haptic feedback to a user of the device 300.

The LFE devices 310, 315, 320, and 325 may be haptic actuators (e.g., haptic actuator(s) 225 as described in FIG. 2) for providing haptic feedback to a user wearing the vest 305. The device 300 may include a number of haptic actuators that may be grouped by channels. The haptic actuators may be grouped and may receive inputs as described in FIG. 2.

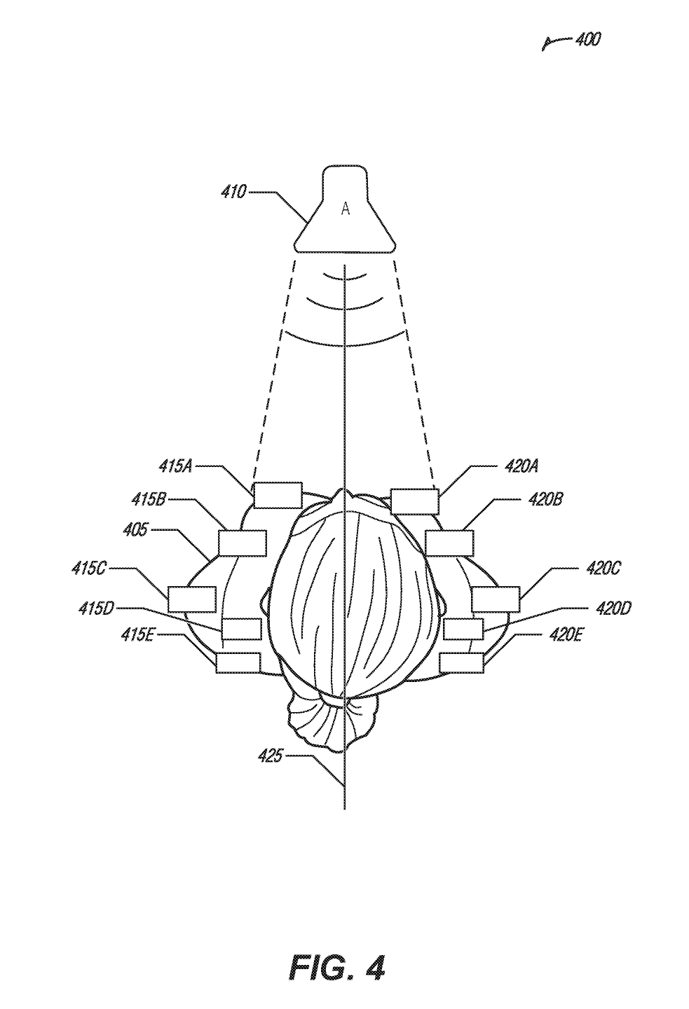

FIG. 4 illustrates an example of haptic device placement in a fixed group configuration 400 for directional haptics for immersive virtual reality, according to an embodiment. The fixed device configuration 400 may include the functionality as described in FIG. 2.

The stereo audio configuration may include a user 405, and an audio source A 410. The user 405 may be wearing (e.g., in a vest, smart shirt, etc.) a variety of haptic actuators configured in a right group and a left group. The left group may include haptic actuators 415A, 415B, 415C, 415D, and 415E. The right group may include haptic actuators 420A, 420B, 420C, 420D, and 420E. The right group and the left group may be logically separated by the dividing line 425 indicating separation between a left audio channel and a right audio channel.

Stereo audio may be output to and received as input by the haptics actuators in the right group and the left group (e.g., spatial audio generated using a head orientation of the user 405). Spatial audio may be generated based on orientation of the head of the user 405 and/or the orientation of the device (e.g., device 300 as described in FIGS. 3A and 3B, vest, smart shirt, etc.) containing the haptics actuators. In an example, in non-head mounted display situations (e.g., PC gaming, etc.) the spatial audio may be generated based on an orientation of a character of the user 405 in a game. The spatial audio generated using the head orientation of the user 405 may be output to an audio device (e.g., headphones, etc.). Spatial audio generated using the orientation of the device containing the haptics actuators may be output to the haptics actuators based on group membership (e.g., left channel signals to left group, right channel signals to right group, etc.).

Left and right weightages may be calculated for each haptic to generate a signal to be output to one or more of the haptics actuators based on its position. In an example, the equation S(t)=Wl×Al(t)+Wr×Ar(t) may be used to generate the signal where S is an input signal given to a haptic actuator, Al and Ar are left and right channel respectively, and Wl and Wr are left and right weightage respectively. For example, for a haptics actuator at a left most position (e.g., haptics actuator 415C, etc.) may have weighting values Wl=1.0 and Wr=0.0. In another example, for a haptics actuator at a right most position (e.g., haptics actuator 420C, etc.) may have weighting values Wl=0.0 and Wr=1.0. In another example, for a haptic actuator halfway on the right side (e.g., haptics actuator 420B, etc.) may have weighting values Wl=0.2 and Wr=0.8. The values may be tuned using a variety of techniques. For example, the weighting values may be used as input to a machine learning algorithm to tune the weightages. In an example, the machine learning algorithm may receive user feedback (e.g., local feedback, community feedback, etc.) to optimize the weightages.

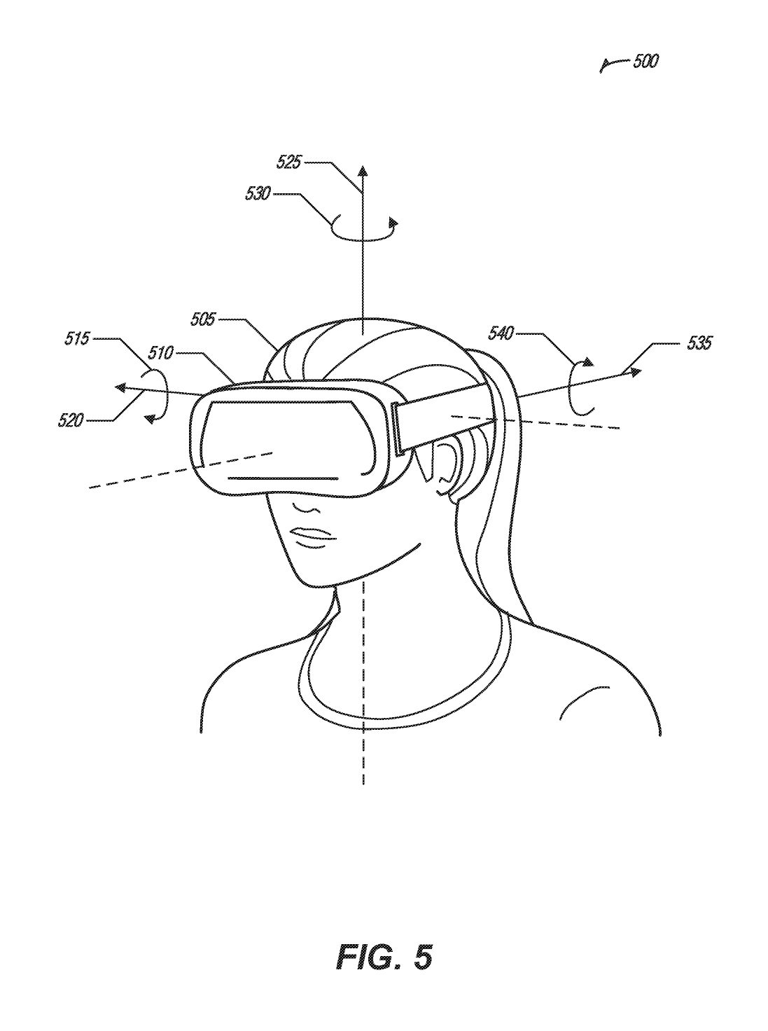

FIG. 5 illustrates and example of directional inputs 500 used in grouping haptic actuators for directional haptics for immersive virtual reality, according to an embodiment. The directional inputs 500 may be used as described in FIG. 2 to determine the orientation of a device.

The directional inputs 500 may be received from a user 505 wearing a head mounted display 510 and may include pitch 520 around and X axis 515, yaw 530 around a Y axis 525, and roll 540 around a Z axis 535. A YZ plane may be created that may be aligned with rotation (e.g., yaw 530) around the Y axis 525 and rotation (e.g., roll 540) around the Z axis 535. Haptics actuators located on the left side of the YZ plane may be grouped into a left group while haptics actuators located on the right side of the YZ plane may be grouped into a right group. Left and right weightages may be calculated for each haptic actuator to generate a signal to be output to a haptic actuator based on its position within the YZ plane. For example, haptics actuators may further from the center of the YZ plane may be weighted more heavily to their respective side (e.g., right or left) than haptics actuators located nearer the center of the YZ plane.

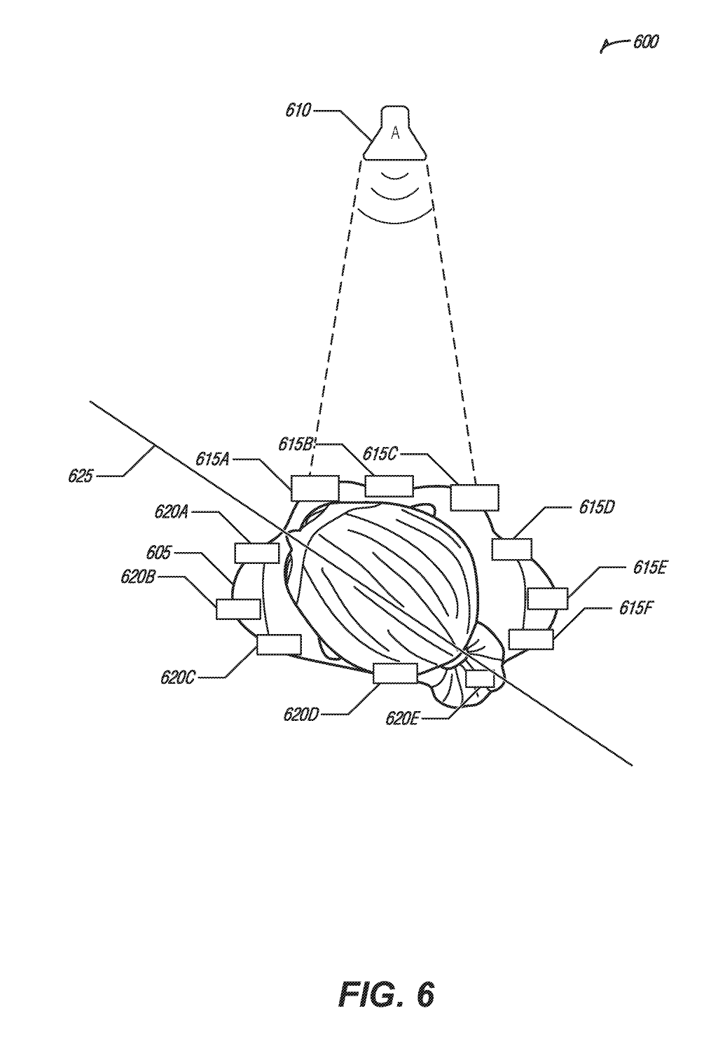

FIG. 6 illustrates an example of haptic device placement in a dynamic group configuration 600 for directional haptics for immersive virtual reality, according to an embodiment. The dynamic group configuration 600 may include functionality as described in FIG. 2.

The dynamic group configuration 600 may include a user 605, an audio source A 610, and a variety of haptic actuators logically separated by YZ plane 625 aligned with rotation of a head of the user 605 around a Y axis and a Z axis (e.g., yaw and roll respectively. The haptic actuators located to the right of the YZ plane 625 may be placed in a right group including haptic actuators 615A, 615B, 615C. 615D, 615E, and 615F and the haptic actuators located to the left of the YZ plane may be grouped into a left group including haptic actuators 620A, 620B, 620C, 620D, and 620E. The haptic actuators may be grouped dynamically into the left and right groups based on an orientation of the head of the user 605 and/or an orientation of a device (e.g., device 300 as described in FIGS. 3A and 3B, a vest, a smart shirt, etc.) including the haptic actuators.

Left and right weightages may be calculated for one or more haptic actuators to generate a signal to be output the one or more haptic actuators based on its position in relation to the YZ plane 625. Spatial audio may be generated based on the orientation of the head of the user 605. The spatial audio may be output to one or both of an audio device (e.g., headphones, etc.) and the one or more haptic actuators. The group membership of the haptic actuators may be updated as the orientation of the head of the user 605 and/or the orientation of the device including the haptic actuators changes.

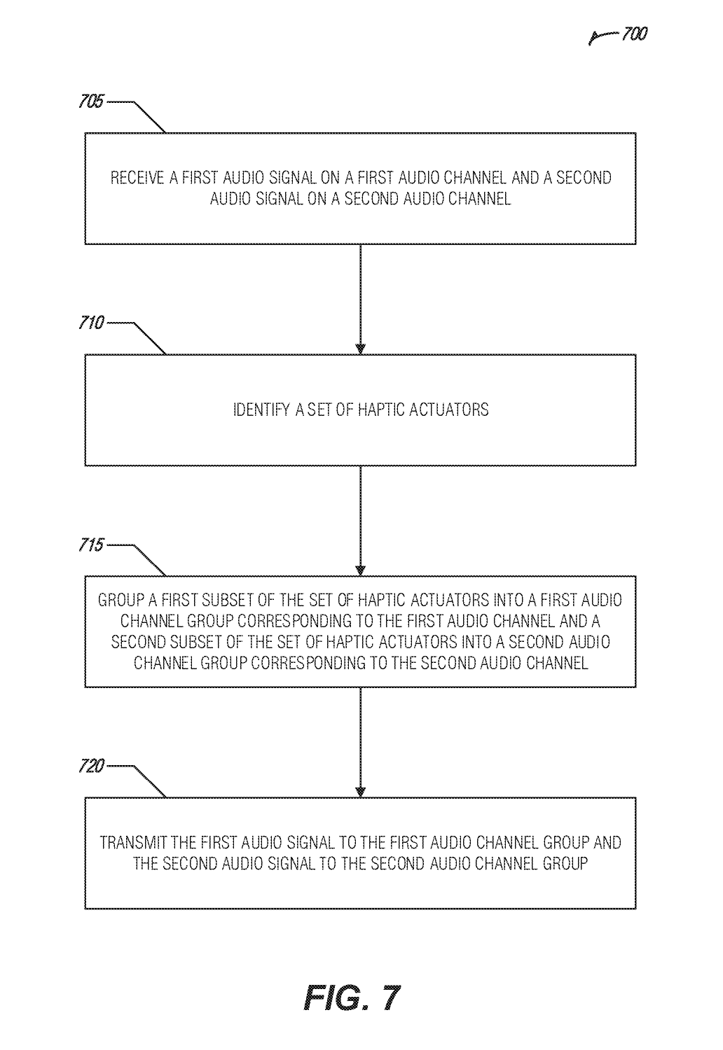

FIG. 7 illustrates a flow diagram of an example of a method 700 for directional haptics for immersive virtual reality, according to an embodiment. The method 700 may provide functionality as described in FIGS. 1, 2, 3, 4, 5, and 6.

At operation 705, a first audio signal may be received on a first audio channel and a second audio signal may be received on a second audio channel. In an example a source audio signal may be obtained. An orientation of a headset may be calculated using a sensor and spatial audio may be generated including the first audio signal and the second audio signal based on the orientation of the headset.

In an example, a source audio signal may be obtained. An orientation of a wearable device including the set of haptic actuators may be calculated using a sensor and spatial audio may be generated including the first audio signal and the second audio signal based on the orientation of the wearable device including the set of haptic actuators.

In an example, a source audio signal may be obtained. An orientation of a player character in an electronic game may be calculated and spatial audio may be generated including the first audio signal and the second audio signal based on the orientation of the player character in the electronic game.

At operation 710, a set of haptic actuators may be identified. For example, a device such as, for example, vest 305 as described in FIG. 3 may include one or more haptic actuators which may be identified (e.g., by the haptic actuator controller 210 as described in FIG. 2).

At operation 715, a first subset of the set of haptic actuators may be grouped into a first audio channel group corresponding to the first audio channel and a second subset of the set of haptic actuators may be grouped into a second audio channel group corresponding to the second audio channel. In an example, a plane of rotation may be identified of the headset around a first axis and a second axis. The grouping of the first subset of the set of haptic actuators into the first audio channel group corresponding to the first audio channel and the second subset of the set of haptic actuators into the second audio channel group corresponding to the second audio channel may be based on determining that the first subset of haptic actuators is on a first side of the plane of rotation and the second subset of haptic actuators is on a second side of the plane of rotation.

In an example, a centerline of the wearable device including the set of haptic actuators may be identified. The grouping of the first subset of the set of haptic actuators into the first audio channel group corresponding to the first audio channel and the second subset of the set of haptic actuators into the second audio channel group corresponding to the second audio channel may use the centerline of the wearable device including the set of haptic actuators

At operation 720, the first audio signal may be transmitted to the first audio channel group and the second audio signal may be transmitted to the second audio channel group. In an example, the first audio signal and the second audio signal may be transmitted via a wireless network. In an example, the first audio signal and the second audio signal may be transmitted via a wired network.

In an example, a distance from the plane of rotation may be calculated for a haptic actuator of the set of haptic actuators. An amplitude of an audio signal to be transmitted to the haptic actuator may be altered based on the distance from the plane of rotation and the altered audio signal may be transmitted to the haptic actuator. In an example, a first directional weighting and a second directional weighting may be determined for the haptic actuator using the distance from the plane of rotation. A first directional amplitude may be multiplied by the first directional weighting to create a first direction adjusted amplitude and a second directional amplitude may be multiplied by the second directional weighting to create a second direction adjusted amplitude. The altered audio signal may comprise the sum of the first direction adjusted amplitude and the second direction adjusted amplitude.

In an example, a distance from the centerline may be calculated for a haptic actuator of the set of haptic actuators. An amplitude of an audio signal to be transmitted to the haptic actuator may be altered based on the distance from the centerline and the altered audio signal may be transmitted to the haptic actuator. In an example, a first directional weighting and a second directional weighting may be determined for the haptic actuator using the distance from the centerline. A first directional amplitude may be multiplied by the first directional weighting to create a first direction adjusted amplitude and a second directional amplitude may be multiplied by the second directional weighting to create a second direction adjusted amplitude. The altered audio signal may comprise the sum of the first direction adjusted amplitude and the second direction adjusted amplitude.

In an example, the spatial audio including the first audio signal and the second audio signal may be transmitted to the headset. The first audio signal may be transmitted to a first speaker included with the headset and the second audio signal may be transmitted to a second speaker included with the headset.

In an example, a low frequency effect signal may be obtained and the low frequency effect signal may be transmitted to the first audio channel group and the second audio channel group.

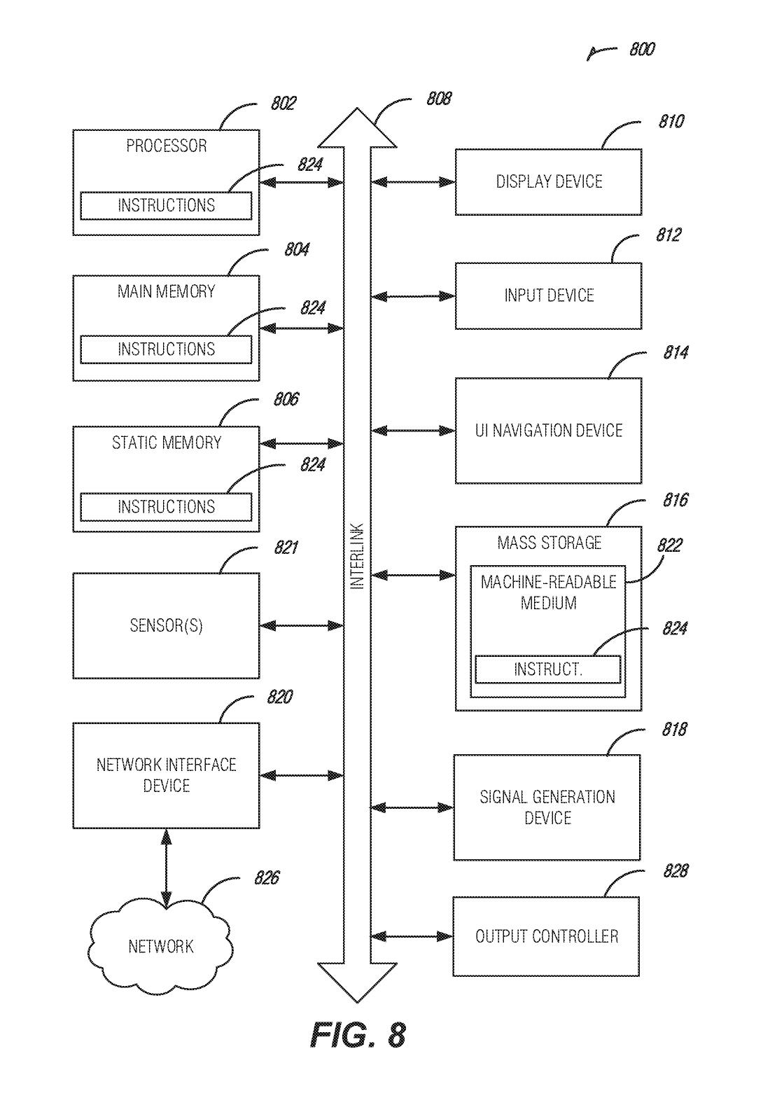

FIG. 8 illustrates a block diagram of an example machine 800 upon which any one or more of the techniques (e.g., methodologies) discussed herein may perform. In alternative embodiments, the machine 800 may operate as a standalone device or may be connected (e.g., networked) to other machines. In a networked deployment, the machine 800 may operate in the capacity of a server machine, a client machine, or both in server-client network environments. In an example, the machine 800 may act as a peer machine in peer-to-peer (P2P) (or other distributed) network environment. The machine 800 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuit sets are a collection of circuits implemented in tangible entities that include hardware (e.g., simple circuits, gates, logic, etc.). Circuit set membership may be flexible over time and underlying hardware variability. Circuit sets include members that may, alone or in combination, perform specified operations when operating. In an example, hardware of the circuit set may be immutably designed to carry out a specific operation (e.g., hardwired). In an example, the hardware of the circuit set may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuit set in hardware via the variable connections to carry out portions of the specific operation when in operation. Accordingly, the computer readable medium is communicatively coupled to the other components of the circuit set member when the device is operating. In an example, any of the physical components may be used in more than one member of more than one circuit set. For example, under operation, execution units may be used in a first circuit of a first circuit set at one point in time and reused by a second circuit in the first circuit set, or by a third circuit in a second circuit set at a different time.

Machine (e.g., computer system) 800 may include a hardware processor 802 (e.g., a central processing unit (CPU), a graphics processing unit (GPU), a hardware processor core, or any combination thereof), a main memory 804 and a static memory 806, some or all of which may communicate with each other via an interlink (e.g., bus) 808. The machine 800 may further include a display unit 810, an alphanumeric input device 812 (e.g., a keyboard), and a user interface (UI) navigation device 814 (e.g., a mouse). In an example, the display unit 810, input device 812 and UI navigation device 814 may be a touch screen display. The machine 800 may additionally include a storage device (e.g., drive unit) 816, a signal generation device 818 (e.g., a speaker), a network interface device 820, and one or more sensors 821, such as a global positioning system (GPS) sensor, compass, accelerometer, or other sensor. The machine 800 may include an output controller 828, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 816 may include a machine readable medium 822 on which is stored one or more sets of data structures or instructions 824 (e.g., software) embodying or utilized by any one or more of the techniques or functions described herein. The instructions 824 may also reside, completely or at least partially, within the main memory 804, within static memory 806, or within the hardware processor 802 during execution thereof by the machine 800. In an example, one or any combination of the hardware processor 802, the main memory 804, the static memory 806, or the storage device 816 may constitute machine readable media.

While the machine readable medium 822 is illustrated as a single medium, the term “machine readable medium” may include a single medium or multiple media (e.g., a centralized or distributed database, and/or associated caches and servers) configured to store the one or more instructions 824.

The term “machine readable medium” may include any medium that is capable of storing, encoding, or carrying instructions for execution by the machine 800 and that cause the machine 800 to perform any one or more of the techniques of the present disclosure, or that is capable of storing, encoding or carrying data structures used by or associated with such instructions. Non-limiting machine readable medium examples may include solid-state memories, and optical and magnetic media. In an example, a massed machine readable medium comprises a machine readable medium with a plurality of particles having invariant (e.g., rest) mass. Accordingly, massed machine-readable media are not transitory propagating signals. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 824 may further be transmitted or received over a communications network 826 using a transmission medium via the network interface device 820 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 820 may include one or more physical jacks (e.g., Ethernet, coaxial, or phone jacks) or one or more antennas to connect to the communications network 826. In an example, the network interface device 820 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 800, and includes digital or analog communications signals or other intangible medium to facilitate communication of such software.

### Additional Notes and Examples

Example 1 is a system to group a set of haptic actuators for immersive virtual reality, the system comprising: at least one processor, and machine readable media including instructions that, when executed by the at least one processor, cause the at least one processor to: obtain a first audio signal on a first audio channel and a second audio signal on a second audio channel; group a first subset of the set of haptic actuators into a first audio channel group corresponding to the first audio channel and a second subset of the set of haptic actuators into a second audio channel group corresponding to the second audio channel; and provide the first audio signal to the first audio channel group and the second audio signal to the second audio channel group.

In Example 2, the subject matter of Example 1 optionally includes wherein the instructions to obtain the first audio signal and the second audio signal include instructions to: obtain a source audio signal; calculate an orientation of a headset using a sensor; and generate spatial audio that includes the first audio signal and the second audio signal based on the orientation of the headset.

In Example 3, the subject matter of Example 2 optionally includes wherein the instructions to calculate the orientation of the headset includes instructions to: identify a plane of rotation of the headset around a first axis and a second axis, wherein the grouping of the first subset of the set of haptic actuators into the first audio channel group corresponding to the first audio channel and the second subset of the set of haptic actuators into the second audio channel group corresponding to the second audio channel is based on determining that the first subset of haptic actuators is on a first side of the plane of rotation and the second subset of haptic actuators is on a second side of the plane of rotation.

In Example 4, the subject matter of Example 3 optionally includes instructions to: calculate a distance from the plane of rotation for a haptic actuator of the set of haptic actuators; alter an amplitude of an audio signal to be transmitted to the haptic actuator based on the distance from the plane of rotation; and transmit the altered audio signal to the haptic actuator.

In Example 5, the subject matter of Example 4 optionally includes instructions to: determine a first directional weighting and a second directional weighting for the haptic actuator using the distance from the plane of rotation; and multiply a first directional amplitude by the first directional weighting to create a first direction adjusted amplitude; and multiply a second directional amplitude by the second directional weighting to create a second direction adjusted amplitude, wherein the altered audio signal comprises the sum of the first direction adjusted amplitude and the second direction adjusted amplitude.

In Example 6, the subject matter of any one or more of Examples 2-5 optionally include instructions to transmit the spatial audio to the headset, wherein the first audio signal is transmitted to a first speaker included with the headset and the second audio signal is transmitted to a second speaker included with the headset.

In Example 7, the subject matter of any one or more of Examples 1-6 optionally include wherein the instructions to obtain the first audio signal and the second audio signal include instructions to: obtain a source audio signal; calculate an orientation of a wearable device including the set of haptic actuators using a sensor; and generate spatial audio that includes the first audio signal and the second audio signal based on the orientation of the wearable device including the set of haptic actuators.

In Example 8, the subject matter of Example 7 optionally includes wherein the instructions to calculate the orientation of the wearable device including the set of haptic actuators includes instructions to: identify a centerline of the wearable device including the set of haptic actuators, wherein the grouping of the first subset of the set of haptic actuators into the first audio channel group corresponding to the first audio channel and the second subset of the set of haptic actuators into the second audio channel group corresponding to the second audio channel uses the centerline of the wearable device including the set of haptic actuators.

In Example 9, the subject matter of Example 8 optionally includes instructions to: calculate a distance from the centerline for a haptic actuator of the set of haptic actuators; alter an amplitude of an audio signal to be transmitted to the haptic actuator based on the distance from the centerline; and transmit the altered audio signal to the haptic actuator.

In Example 10, the subject matter of Example 9 optionally includes instructions to: determine a first directional weighting and a second directional weighting for the haptic actuator using the distance from the centerline; and multiply a first directional amplitude by the first directional weighting to create a first direction adjusted amplitude; and multiply a second directional amplitude by the second directional weighting to create a second direction adjusted amplitude, wherein the altered audio signal comprises the sum of the first direction adjusted amplitude and the second direction adjusted amplitude.

In Example 11, the subject matter of any one or more of Examples 1-10 optionally include wherein the instructions to obtain the first audio signal and the second audio signal include instructions to: obtain a source audio signal; calculate an orientation of a player character in an electronic game; and generate spatial audio that includes the first audio signal and the second audio signal based on the orientation of the player character in the electronic game.

In Example 12, the subject matter of any one or more of Examples 1-11 optionally include instructions to: obtain a low frequency effect signal; and transmit the low frequency effect signal to the first audio channel group and the second audio channel group.

In Example 13, the subject matter of any one or more of Examples 1-12 optionally include wherein the first audio signal and the second audio signal are transmitted via a wireless network.

In Example 14, the subject matter of any one or more of Examples 1-13 optionally include wherein the first audio signal and the second audio signal are transmitted via a wired network.

In Example 15, the subject matter of any one or more of Examples 1-14 optionally include wherein the first audio channel and the second audio channel are channels in a multi-channel audio signal, wherein the set of haptic actuators are a portion of all haptic actuators, wherein haptic actuators other than the set of haptic actuators are grouped with channels in the multi-channel audio signal other than the first audio channel and the second audio channel.

In Example 16, the subject matter of Example 15 optionally includes wherein the multi-channel audio signal has six channels.

In Example 17, the subject matter of any one or more of Examples 1-16 optionally include wherein the instructions to provide the first audio signal to the first audio channel group and the second audio signal to the second audio channel group includes instructions to: convert the first audio signal and the second audio signal to another signal format, wherein the first audio signal is provided to the first audio channel group using the other signal format, and wherein the second audio signal is provided to the second audio channel group using the other signal format.

In Example 18, the subject matter of Example 17 optionally includes wherein the other signal format is pulse-width modulation.

Example 19 is at least one machine readable medium including instructions to group a set of haptic actuators for immersive virtual reality that, when executed by a machine, cause the machine to: obtain a first audio signal on a first audio channel and a second audio signal on a second audio channel; group a first subset of the set of haptic actuators into a first audio channel group corresponding to the first audio channel and a second subset of the set of haptic actuators into a second audio channel group corresponding to the second audio channel; and provide the first audio signal to the first audio channel group and the second audio signal to the second audio channel group.

In Example 20, the subject matter of Example 19 optionally includes wherein the instructions to obtain the first audio signal and the second audio signal include instructions to: obtain a source audio signal; calculate an orientation of a headset using a sensor; and generate spatial audio that includes the first audio signal and the second audio signal based on the orientation of the headset.

In Example 21, the subject matter of Example 20 optionally includes wherein the instructions to calculate the orientation of the headset includes instructions to: identify a plane of rotation of the headset around a first axis and a second axis, wherein the grouping of the first subset of the set of haptic actuators into the first audio channel group corresponding to the first audio channel and the second subset of the set of haptic actuators into the second audio channel group corresponding to the second audio channel is based on determining that the first subset of haptic actuators is on a first side of the plane of rotation and the second subset of haptic actuators is on a second side of the plane of rotation.

In Example 22, the subject matter of Example 21 optionally includes instructions to: calculate a distance from the plane of rotation for a haptic actuator of the set of haptic actuators; alter an amplitude of an audio signal to be transmitted to the haptic actuator based on the distance from the plane of rotation; and transmit the altered audio signal to the haptic actuator.

In Example 23, the subject matter of Example 22 optionally includes instructions to: determine a first directional weighting and a second directional weighting for the haptic actuator using the distance from the plane of rotation, and multiply a first directional amplitude by the first directional weighting to create a first direction adjusted amplitude; and multiply a second directional amplitude by the second directional weighting to create a second direction adjusted amplitude, wherein the altered audio signal comprises the sum of the first direction adjusted amplitude and the second direction adjusted amplitude.

In Example 24, the subject matter of any one or more of Examples 20-23 optionally include instructions to transmit the spatial audio to the headset, wherein the first audio signal is transmitted to a first speaker included with the headset and the second audio signal is transmitted to a second speaker included with the headset.

In Example 25, the subject matter of any one or more of Examples 19-24 optionally include wherein the instructions to obtain the first audio signal and the second audio signal include instructions to: obtain a source audio signal; calculate an orientation of a wearable device including the set of haptic actuators using a sensor; and generate spatial audio that includes the first audio signal and the second audio signal based on the orientation of the wearable device including the set of haptic actuators.

In Example 26, the subject matter of Example 25 optionally includes wherein the instructions to calculate the orientation of the wearable device including the set of haptic actuators includes instructions to: identify a centerline of the wearable device including the set of haptic actuators, wherein the grouping of the first subset of the set of haptic actuators into the first audio channel group corresponding to the first audio channel and the second subset of the set of haptic actuators into the second audio channel group corresponding to the second audio channel uses the centerline of the wearable device including the set of haptic actuators.

In Example 27, the subject matter of Example 26 optionally includes instructions to: calculate a distance from the centerline for a haptic actuator of the set of haptic actuators; alter an amplitude of an audio signal to be transmitted to the haptic actuator based on the distance from the centerline; and transmit the altered audio signal to the haptic actuator.

In Example 28, the subject matter of Example 27 optionally includes instructions to: determine a first directional weighting and a second directional weighting for the haptic actuator using the distance from the centerline; and multiply a first directional amplitude by the first directional weighting to create a first direction adjusted amplitude; and multiply a second directional amplitude by the second directional weighting to create a second direction adjusted amplitude, wherein the altered audio signal comprises the sum of the first direction adjusted amplitude and the second direction adjusted amplitude.

In Example 29, the subject matter of any one or more of Examples 19-28 optionally include wherein the instructions to obtain the first audio signal and the second audio signal include instructions to: obtain a source audio signal; calculate an orientation of a player character in an electronic game; and generate spatial audio that includes the first audio signal and the second audio signal based on the orientation of the player character in the electronic game.

In Example 30, the subject matter of any one or more of Examples 19-29 optionally include instructions to: obtain a low frequency effect signal; and transmit the low frequency effect signal to the first audio channel group and the second audio channel group.

In Example 31, the subject matter of any one or more of Examples 19-30 optionally include wherein the first audio signal and the second audio signal are transmitted via a wireless network.

In Example 32, the subject matter of any one or more of Examples 19-31 optionally include wherein the first audio signal and the second audio signal are transmitted via a wired network.

In Example 33, the subject matter of any one or more of Examples 19-32 optionally include wherein the first audio channel and the second audio channel are channels in a multi-channel audio signal, wherein the set of haptic actuators are a portion of all haptic actuators, wherein haptic actuators other than the set of haptic actuators are grouped with channels in the multi-channel audio signal other than the first audio channel and the second audio channel.

In Example 34, the subject matter of Example 33 optionally includes wherein the multi-channel audio signal has six channels.

In Example 35, the subject matter of any one or more of Examples 19-34 optionally include wherein the instructions to provide the first audio signal to the first audio channel group and the second audio signal to the second audio channel group includes instructions to: convert the first audio signal and the second audio signal to another signal format, wherein the first audio signal is provided to the first audio channel group using the other signal format, and wherein the second audio signal is provided to the second audio channel group using the other signal format.

In Example 36, the subject matter of Example 35 optionally includes wherein the other signal format is pulse-width modulation.

Example 37 is a method of grouping a set of haptic actuators for immersive virtual reality, the method comprising: obtaining a first audio signal on a first audio channel and a second audio signal on a second audio channel; grouping a first subset of the set of haptic actuators into a first audio channel group corresponding to the first audio channel and a second subset of the set of haptic actuators into a second audio channel group corresponding to the second audio channel; and providing the first audio signal to the first audio channel group and the second audio signal to the second audio channel group.

In Example 38, the subject matter of Example 37 optionally includes wherein obtaining the first audio signal and the second audio signal includes: obtaining a source audio signal; calculating an orientation of a headset using a sensor; and generating spatial audio that includes the first audio signal and the second audio signal based on the orientation of the headset.

In Example 39, the subject matter of Example 38 optionally includes wherein calculating the orientation of the headset includes: identifying a plane of rotation of the headset around a first axis and a second axis, wherein the grouping of the first subset of the set of haptic actuators into the first audio channel group corresponding to the first audio channel and the second subset of the set of haptic actuators into the second audio channel group corresponding to the second audio channel is based on determining that the first subset of haptic actuators is on a first side of the plane of rotation and the second subset of haptic actuators is on a second side of the plane of rotation.

In Example 40, the subject matter of Example 39 optionally includes calculating a distance from the plane of rotation for a haptic actuator of the set of haptic actuators; altering an amplitude of an audio signal to be transmitted to the haptic actuator based on the distance from the plane of rotation; and transmitting the altered audio signal to the haptic actuator.

In Example 41, the subject matter of Example 40 optionally includes determining a first directional weighting and a second directional weighting for the haptic actuator using the distance from the plane of rotation; and multiplying a first directional amplitude by the first directional weighting to create a first direction adjusted amplitude; and multiplying a second directional amplitude by the second directional weighting to create a second direction adjusted amplitude, wherein the altered audio signal comprises the sum of the first direction adjusted amplitude and the second direction adjusted amplitude.

In Example 42, the subject matter of any one or more of Examples 38-41 optionally include transmitting the spatial audio to the headset, wherein the first audio signal is transmitted to a first speaker included with the headset and the second audio signal is transmitted to a second speaker included with the headset.

In Example 43, the subject matter of any one or more of Examples 37-42 optionally include wherein obtaining the first audio signal and the second audio signal includes: obtaining a source audio signal; calculating an orientation of a wearable device including the set of haptic actuators using a sensor; and generating spatial audio that includes the first audio signal and the second audio signal based on the orientation of the wearable device including the set of haptic actuators.

In Example 44, the subject matter of Example 43 optionally includes wherein calculating the orientation of the wearable device including the set of haptic actuators includes: identifying a centerline of the wearable device including the set of haptic actuators, wherein the grouping of the first subset of the set of haptic actuators into the first audio channel group corresponding to the first audio channel and the second subset of the set of haptic actuators into the second audio channel group corresponding to the second audio channel uses the centerline of the wearable device including the set of haptic actuators.

In Example 45, the subject matter of Example 44 optionally includes calculating a distance from the centerline for a haptic actuator of the set of haptic actuators; altering an amplitude of an audio signal to be transmitted to the haptic actuator based on the distance from the centerline; and transmitting the altered audio signal to the haptic actuator.

In Example 46, the subject matter of Example 45 optionally includes determining a first directional weighting and a second directional weighting for the haptic actuator using the distance from the centerline; and multiplying a first directional amplitude by the first directional weighting to create a first direction adjusted amplitude; and multiplying a second directional amplitude by the second directional weighting to create a second direction adjusted amplitude, wherein the altered audio signal comprises the sum of the first direction adjusted amplitude and the second direction adjusted amplitude.

In Example 47, the subject matter of any one or more of Examples 37-46 optionally include wherein obtaining the first audio signal and the second audio signal includes: obtaining a source audio signal; calculating an orientation of a player character in an electronic game; and generating spatial audio that includes the first audio signal and the second audio signal based on the orientation of the player character in the electronic game.

In Example 48, the subject matter of any one or more of Examples 37-47 optionally include obtaining a low frequency effect signal; and transmitting the low frequency effect signal to the first audio channel group and the second audio channel group.

In Example 49, the subject matter of any one or more of Examples 37-48 optionally include wherein the first audio signal and the second audio signal are transmitted via a wireless network.

In Example 50, the subject matter of any one or more of Examples 37-49 optionally include wherein the first audio signal and the second audio signal are transmitted via a wired network.

In Example 51, the subject matter of any one or more of Examples 37-50 optionally include wherein the first audio channel and the second audio channel are channels in a multi-channel audio signal, wherein the set of haptic actuators are a portion of all haptic actuators, wherein haptic actuators other than the set of haptic actuators are grouped with channels in the multi-channel audio signal other than the first audio channel and the second audio channel.

In Example 52, the subject matter of Example 51 optionally includes wherein the multi-channel audio signal has six channels.

In Example 53, the subject matter of any one or more of Examples 37-52 optionally include wherein providing the first audio signal to the first audio channel group and the second audio signal to the second audio channel group includes: converting the first audio signal and the second audio signal to another signal format, wherein the first audio signal is provided to the first audio channel group using the other signal format, and wherein the second audio signal is provided to the second audio channel group using the other signal format.

In Example 54, the subject matter of Example 53 optionally includes wherein the other signal format is pulse-width modulation.

Example 55 is a system to implement grouping a set of haptic actuators for immersive virtual reality, the system comprising means to perform any method of Examples 37-54.

Example 56 is at least one machine readable medium to implement grouping a set of haptic actuators for immersive virtual reality, the at least one machine readable medium including instructions that, when executed by a machine, cause the machine to perform any method of Examples 37-54.

Example 57 is a system to group a set of haptic actuators for immersive virtual reality, the system comprising: means for obtaining a first audio signal on a first audio channel and a second audio signal on a second audio channel; means for grouping a first subset of the set of haptic actuators into a first audio channel group corresponding to the first audio channel and a second subset of the set of haptic actuators into a second audio channel group corresponding to the second audio channel; and means for providing the first audio signal to the first audio channel group and the second audio signal to the second audio channel group.

In Example 58, the subject matter of Example 57 optionally includes wherein obtaining the first audio signal and the second audio signal includes: means for obtaining a source audio signal; means for calculating an orientation of a headset using a sensor; and means for generating spatial audio that includes the first audio signal and the second audio signal based on the orientation of the headset.

In Example 59, the subject matter of Example 58 optionally includes wherein the means for calculating the orientation of the headset includes: means for identifying a plane of rotation of the headset around a first axis and a second axis, wherein the grouping of the first subset of the set of haptic actuators into the first audio channel group corresponding to the first audio channel and the second subset of the set of haptic actuators into the second audio channel group corresponding to the second audio channel is based on determining that the first subset of haptic actuators is on a first side of the plane of rotation and the second subset of haptic actuators is on a second side of the plane of rotation.

In Example 60, the subject matter of Example 59 optionally includes means for calculating a distance from the plane of rotation for a haptic actuator of the set of haptic actuators; means for altering an amplitude of an audio signal to be transmitted to the haptic actuator based on the distance from the plane of rotation; and means for transmitting the altered audio signal to the haptic actuator.

In Example 61, the subject matter of Example 60 optionally includes means for determining a first directional weighting and a second directional weighting for the haptic actuator using the distance from the plane of rotation; and means for multiplying a first directional amplitude by the first directional weighting to create a first direction adjusted amplitude; and means for multiplying a second directional amplitude by the second directional weighting to create a second direction adjusted amplitude, wherein the altered audio signal comprises the sum of the first direction adjusted amplitude and the second direction adjusted amplitude.

In Example 62, the subject matter of any one or more of Examples 58-61 optionally include means for transmitting the spatial audio to the headset, wherein the first audio signal is transmitted to a first speaker included with the headset and the second audio signal is transmitted to a second speaker included with the headset.

In Example 63, the subject matter of any one or more of Examples 57-62 optionally include wherein obtaining the first audio signal and the second audio signal includes: means for obtaining a source audio signal; means for calculating an orientation of a wearable device including the set of haptic actuators using a sensor; and means for generating spatial audio that includes the first audio signal and the second audio signal based on the orientation of the wearable device including the set of haptic actuators.

In Example 64, the subject matter of Example 63 optionally includes wherein means for calculating the orientation of the wearable device including the set of haptic actuators includes: means for identifying a centerline of the wearable device including the set of haptic actuators, wherein the grouping of the first subset of the set of haptic actuators into the first audio channel group corresponding to the first audio channel and the second subset of the set of haptic actuators into the second audio channel group corresponding to the second audio channel uses the centerline of the wearable device including the set of haptic actuators.

In Example 65, the subject matter of Example 64 optionally includes means for calculating a distance from the centerline for a haptic actuator of the set of haptic actuators; means for altering an amplitude of an audio signal to be transmitted to the haptic actuator based on the distance from the centerline; and means for transmitting the altered audio signal to the haptic actuator.

In Example 66, the subject matter of Example 65 optionally includes means for determining a first directional weighting and a second directional weighting for the haptic actuator using the distance from the centerline; and means for multiplying a first directional amplitude by the first directional weighting to create a first direction adjusted amplitude; and means for multiplying a second directional amplitude by the second directional weighting to create a second direction adjusted amplitude, wherein the altered audio signal comprises the sum of the first direction adjusted amplitude and the second direction adjusted amplitude.

In Example 67, the subject matter of any one or more of Examples 57-66 optionally include wherein obtaining the first audio signal and the second audio signal includes: means for obtaining a source audio signal; means for calculating an orientation of a player character in an electronic game; and means for generating spatial audio that includes the first audio signal and the second audio signal based on the orientation of the player character in the electronic game.

In Example 68, the subject matter of any one or more of Examples 57-67 optionally include means for obtaining a low frequency effect signal; and means for transmitting the low frequency effect signal to the first audio channel group and the second audio channel group.

In Example 69, the subject matter of any one or more of Examples 57-68 optionally include means for transmitting the first audio signal and the second audio signal via a wireless network.

In Example 70, the subject matter of any one or more of Examples 57-69 optionally include means for transmitting the first audio signal and the second audio signal via a wired network.

In Example 71, the subject matter of any one or more of Examples 57-70 optionally include wherein the first audio channel and the second audio channel are channels in a multi-channel audio signal, wherein the set of haptic actuators are a portion of all haptic actuators, wherein haptic actuators other than the set of haptic actuators are grouped with channels in the multi-channel audio signal other than the first audio channel and the second audio channel.

In Example 72, the subject matter of Example 71 optionally includes wherein the multi-channel audio signal has six channels.

In Example 73, the subject matter of any one or more of Examples 57-72 optionally include wherein the means for providing the first audio signal to the first audio channel group and the second audio signal to the second audio channel group includes: means for converting the first audio signal and the second audio signal to another signal format, wherein the first audio signal is provided to the first audio channel group using the other signal format, and wherein the second audio signal is provided to the second audio channel group using the other signal format.

In Example 74, the subject matter of Example 73 optionally includes wherein the other signal format is pulse-width modulation.

Example 75 is an apparatus for directional haptics in immersive virtual reality, the apparatus comprising: a set of haptic actuators; at least one processor; and machine readable media including instructions that, when executed by the at least one processor, cause the at least one processor to: obtain a first audio signal on a first audio channel and a second audio signal on a second audio channel; group a first subset of the set of haptic actuators into a first audio channel group corresponding to the first audio channel and a second subset of the set of haptic actuators into a second audio channel group corresponding to the second audio channel; and provide the first audio signal to the first audio channel group and the second audio signal to the second audio channel group.

In Example 76, the subject matter of Example 75 optionally includes wherein the instructions to obtain the first audio signal and the second audio signal include instructions to: obtain a source audio signal; calculate an orientation of a headset using a sensor; and generate spatial audio that includes the first audio signal and the second audio signal based on the orientation of the headset.

In Example 77, the subject matter of Example 76 optionally includes wherein the instructions to calculate the orientation of the headset includes instructions to: identify a plane of rotation of the headset around a first axis and a second axis, wherein the grouping of the first subset of the set of haptic actuators into the first audio channel group corresponding to the first audio channel and the second subset of the set of haptic actuators into the second audio channel group corresponding to the second audio channel is based on determining that the first subset of haptic actuators is on a first side of the plane of rotation and the second subset of haptic actuators is on a second side of the plane of rotation.

In Example 78, the subject matter of Example 77 optionally includes instructions to: calculate a distance from the plane of rotation for a haptic actuator of the set of haptic actuators; alter an amplitude of an audio signal to be transmitted to the haptic actuator based on the distance from the plane of rotation; and transmit the altered audio signal to the haptic actuator.

In Example 79, the subject matter of Example 78 optionally includes instructions to: determine a first directional weighting and a second directional weighting for the haptic actuator using the distance from the plane of rotation; and multiply a first directional amplitude by the first directional weighting to create a first direction adjusted amplitude; and multiply a second directional amplitude by the second directional weighting to create a second direction adjusted amplitude, wherein the altered audio signal comprises the sum of the first direction adjusted amplitude and the second direction adjusted amplitude.

In Example 80, the subject matter of any one or more of Examples 76-79 optionally include instructions to transmit the spatial audio to the headset, wherein the first audio signal is transmitted to a first speaker included with the headset and the second audio signal is transmitted to a second speaker included with the headset.

In Example 81, the subject matter of any one or more of Examples 75-80 optionally include wherein the instructions to obtain the first audio signal and the second audio signal include instructions to: obtain a source audio signal; calculate an orientation of the apparatus including the set of haptic actuators using a sensor; and generate spatial audio that includes the first audio signal and the second audio signal based on the orientation of the apparatus including the set of haptic actuators.

In Example 82, the subject matter of Example 81 optionally includes wherein the instructions to calculate the orientation of the apparatus including the set of haptic actuators includes instructions to: identify a centerline of the apparatus including the set of haptic actuators, wherein the grouping of the first subset of the set of haptic actuators into the first audio channel group corresponding to the first audio channel and the second subset of the set of haptic actuators into the second audio channel group corresponding to the second audio channel uses the centerline of the apparatus including the set of haptic actuators.

In Example 83, the subject matter of Example 82 optionally includes instructions to: calculate a distance from the centerline for a haptic actuator of the set of haptic actuators; alter an amplitude of an audio signal to be transmitted to the haptic actuator based on the distance from the centerline; and transmit the altered audio signal to the haptic actuator.

In Example 84, the subject matter of Example 83 optionally includes instructions to: determine a first directional weighting and a second directional weighting for the haptic actuator using the distance from the centerline; and multiply a first directional amplitude by the first directional weighting to create a first direction adjusted amplitude; and multiply a second directional amplitude by the second directional weighting to create a second direction adjusted amplitude, wherein the altered audio signal comprises the sum of the first direction adjusted amplitude and the second direction adjusted amplitude.

In Example 85, the subject matter of any one or more of Examples 75-84 optionally include wherein the instructions to obtain the first audio signal and the second audio signal include instructions to: obtain a source audio signal; calculate an orientation of a player character in an electronic game; and generate spatial audio that includes the first audio signal and the second audio signal based on the orientation of the player character in the electronic game.

In Example 86, the subject matter of any one or more of Examples 75-85 optionally include instructions to: obtain a low frequency effect signal; and transmit the low frequency effect signal to the first audio channel group and the second audio channel group.

In Example 87, the subject matter of any one or more of Examples 75-86 optionally include wherein the first audio signal and the second audio signal are transmitted via a wireless network.

In Example 88, the subject matter of any one or more of Examples 75-87 optionally include wherein the first audio signal and the second audio signal are transmitted via a wired network.

In Example 89, the subject matter of any one or more of Examples 75-88 optionally include wherein the first audio channel and the second audio channel are channels in a multi-channel audio signal, wherein the set of haptic actuators are a portion of all haptic actuators, wherein haptic actuators other than the set of haptic actuators are grouped with channels in the multi-channel audio signal other than the first audio channel and the second audio channel.

In Example 90, the subject matter of Example 89 optionally includes wherein the multi-channel audio signal has six channels.

In Example 91, the subject matter of any one or more of Examples 75-90 optionally include wherein the instructions to provide the first audio signal to the first audio channel group and the second audio signal to the second audio channel group includes instructions to: convert the first audio signal and the second audio signal to another signal format, wherein the first audio signal is provided to the first audio channel group using the other signal format, and wherein the second audio signal is provided to the second audio channel group using the other signal format.

In Example 92, the subject matter of Example 91 optionally includes wherein the other signal format is pulse-width modulation.

Example 93 is at least one machine-readable medium including instructions, which when executed by a machine, cause the machine to perform operations of any of the operations of Examples 1-92.

Example 94 is an apparatus comprising means for performing any of the operations of Examples 1-92.

Example 95 is a system to perform the operations of any of the Examples 1-92.

Example 96 is a method to perform the operations of any of the Examples 1-92.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A.” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third.” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

What is claimed is:

1. A system to group a set of haptic actuators for immersive virtual reality, the system comprising:
at least one processor; and
machine readable media including instructions that, when executed by the at least one processor, cause the at least one processor to:
obtain a first audio signal on a first audio channel and a second audio signal on a second audio channel;
group a first subset of the set of haptic actuators into a first audio channel group corresponding to the first audio channel and a second subset of the set of haptic actuators into a second audio channel group corresponding to the second audio channel; and
provide the first audio signal to the first audio channel group and the second audio signal to the second audio channel group.

2. The system of claim 1, wherein the instructions to obtain the first audio signal and the second audio signal include instructions to:
obtain a source audio signal;
calculate an orientation of a headset using a sensor; and
generate spatial audio that includes the first audio signal and the second audio signal based on the orientation of the headset.

3. The system of claim 2, wherein the instructions to calculate the orientation of the headset includes instructions to:
identify a plane of rotation of the headset around a first axis and a second axis, wherein the grouping of the first subset of the set of haptic actuators into the first audio channel group corresponding to the first audio channel and the second subset of the set of haptic actuators into the second audio channel group corresponding to the second audio channel is based on determining that the first subset of haptic actuators is on a first side of the plane of rotation and the second subset of haptic actuators is on a second side of the plane of rotation.

4. The system of claim 3, further comprising instructions to:
calculate a distance from the plane of rotation for a haptic actuator of the set of haptic actuators;
alter an amplitude of an audio signal to be transmitted to the haptic actuator based on the distance from the plane of rotation; and
transmit the altered audio signal to the haptic actuator.

5. The system of claim 4, further comprising instructions to:
determine a first directional weighting and a second directional weighting for the haptic actuator using the distance from the plane of rotation; and
multiply a first directional amplitude by the first directional weighting to create a first direction adjusted amplitude; and
multiply a second directional amplitude by the second directional weighting to create a second direction adjusted amplitude, wherein the altered audio signal comprises the sum of the first direction adjusted amplitude and the second direction adjusted amplitude.

6. The system of claim 1, wherein the instructions to obtain the first audio signal and the second audio signal include instructions to:
obtain a source audio signal;
calculate an orientation of a wearable device including the set of haptic actuators using a sensor; and
generate spatial audio that includes the first audio signal and the second audio signal based on the orientation of the wearable device including the set of haptic actuators.

7. The system of claim 6, wherein the instructions to calculate the orientation of the wearable device including the set of haptic actuators includes instructions to:
identify a centerline of the wearable device including the set of haptic actuators, wherein the grouping of the first subset of the set of haptic actuators into the first audio channel group corresponding to the first audio channel and the second subset of the set of haptic actuators into the second audio channel group corresponding to the second audio channel uses the centerline of the wearable device including the set of haptic actuators.

8. The system of claim 7, further comprising instructions to:
calculate a distance from the centerline for a haptic actuator of the set of haptic actuators;
alter an amplitude of an audio signal to be transmitted to the haptic actuator based on the distance from the centerline; and
transmit the altered audio signal to the haptic actuator.

9. The system of claim 1, wherein the first audio channel and the second audio channel are channels in a multi-channel audio signal, wherein the set of haptic actuators are a portion of all haptic actuators, wherein haptic actuators other than the set of haptic actuators are grouped with channels in the multi-channel audio signal other than the first audio channel and the second audio channel.

10. The system of claim 9, wherein the multi-channel audio signal has six channels.

11. At least one machine readable medium including instructions to group a set of haptic actuators for immersive virtual reality that, when executed by a machine, cause the machine to:
obtain a first audio signal on a first audio channel and a second audio signal on a second audio channel;
group a first subset of the set of haptic actuators into a first audio channel group corresponding to the first audio channel and a second subset of the set of haptic actuators into a second audio channel group corresponding to the second audio channel; and
provide the first audio signal to the first audio channel group and the second audio signal to the second audio channel group.

12. The at least one machine readable medium of claim 11, wherein the instructions to obtain the first audio signal and the second audio signal include instructions to:
obtain a source audio signal;
calculate an orientation of a headset using a sensor; and
generate spatial audio that includes the first audio signal and the second audio signal based on the orientation of the headset.

13. The at least one machine readable medium of claim 12, wherein the instructions to calculate the orientation of the headset includes instructions to:
identify a plane of rotation of the headset around a first axis and a second axis, wherein the grouping of the first subset of the set of haptic actuators into the first audio channel group corresponding to the first audio channel and the second subset of the set of haptic actuators into the second audio channel group corresponding to the second audio channel is based on determining that the first subset of haptic actuators is on a first side of the plane of rotation and the second subset of haptic actuators is on a second side of the plane of rotation.

14. The at least one machine readable medium of claim 13, further comprising instructions to:
calculate a distance from the plane of rotation for a haptic actuator of the set of haptic actuators;
alter an amplitude of an audio signal to be transmitted to the haptic actuator based on the distance from the plane of rotation; and
transmit the altered audio signal to the haptic actuator.

15. The at least one machine readable medium of claim 14, further comprising instructions to:
determine a first directional weighting and a second directional weighting for the haptic actuator using the distance from the plane of rotation; and
multiply a first directional amplitude by the first directional weighting to create a first direction adjusted amplitude; and
multiply a second directional amplitude by the second directional weighting to create a second direction adjusted amplitude, wherein the altered audio signal comprises the sum of the first direction adjusted amplitude and the second direction adjusted amplitude.

16. The at least one machine readable medium of claim 11, wherein the instructions to obtain the first audio signal and the second audio signal include instructions to:
obtain a source audio signal;
calculate an orientation of a wearable device including the set of haptic actuators using a sensor; and
generate spatial audio that includes the first audio signal and the second audio signal based on the orientation of the wearable device including the set of haptic actuators.

17. The at least one machine readable medium of claim 16, wherein the instructions to calculate the orientation of the wearable device including the set of haptic actuators includes instructions to:
identify a centerline of the wearable device including the set of haptic actuators, wherein the grouping of the first subset of the set of haptic actuators into the first audio channel group corresponding to the first audio channel and the second subset of the set of haptic actuators into the second audio channel group corresponding to the second audio channel uses the centerline of the wearable device including the set of haptic actuators.

18. The at least one machine readable medium of claim 17, further comprising instructions to:
calculate a distance from the centerline for a haptic actuator of the set of haptic actuators;
alter an amplitude of an audio signal to be transmitted to the haptic actuator based on the distance from the centerline; and
transmit the altered audio signal to the haptic actuator.

19. The at least one machine readable medium of claim 11, wherein the first audio channel and the second audio channel are channels in a multi-channel audio signal, wherein the set of haptic actuators are a portion of all haptic actuators, wherein haptic actuators other than the set of haptic actuators are grouped with channels in the multi-channel audio signal other than the first audio channel and the second audio channel.

20. The at least one machine readable medium of claim 19, wherein the multi-channel audio signal has six channels.

21. A method of grouping a set of haptic actuators for immersive virtual reality, the method comprising:
obtaining a first audio signal on a first audio channel and a second audio signal on a second audio channel;
grouping a first subset of the set of haptic actuators into a first audio channel group corresponding to the first audio channel and a second subset of the set of haptic actuators into a second audio channel group corresponding to the second audio channel; and
providing the first audio signal to the first audio channel group and the second audio signal to the second audio channel group.

22. The method of claim 21, wherein obtaining the first audio signal and the second audio signal includes:
obtaining a source audio signal;
calculating an orientation of a headset using a sensor; and
generating spatial audio that includes the first audio signal and the second audio signal based on the orientation of the headset.

23. The method of claim 22, wherein calculating the orientation of the headset includes:
identifying a plane of rotation of the headset around a first axis and a second axis, wherein the grouping of the first subset of the set of haptic actuators into the first audio channel group corresponding to the first audio channel and the second subset of the set of haptic actuators into the second audio channel group corresponding to the second audio channel is based on determining that the first subset of haptic actuators is on a first side of the plane of rotation and the second subset of haptic actuators is on a second side of the plane of rotation.

24. The method of claim 23, further comprising:
calculating a distance from the plane of rotation for a haptic actuator of the set of haptic actuators;
altering an amplitude of an audio signal to be transmitted to the haptic actuator based on the distance from the plane of rotation; and
transmitting the altered audio signal to the haptic actuator.

25. The method of claim 24, further comprising:
determining a first directional weighting and a second directional weighting for the haptic actuator using the distance from the plane of rotation; and
multiplying a first directional amplitude by the first directional weighting to create a first direction adjusted amplitude; and
multiplying a second directional amplitude by the second directional weighting to create a second direction adjusted amplitude, wherein the altered audio signal comprises the sum of the first direction adjusted amplitude and the second direction adjusted amplitude.

26. The method of claim 21, wherein obtaining the first audio signal and the second audio signal includes:
obtaining a source audio signal;
calculating an orientation of a wearable device including the set of haptic actuators using a sensor; and
generating spatial audio that includes the first audio signal and the second audio signal based on the orientation of the wearable device including the set of haptic actuators.

27. The method of claim 26, wherein calculating the orientation of the wearable device including the set of haptic actuators includes:
identifying a centerline of the wearable device including the set of haptic actuators, wherein the grouping of the first subset of the set of haptic actuators into the first audio channel group corresponding to the first audio channel and the second subset of the set of haptic actuators into the second audio channel group corresponding to the second audio channel uses the centerline of the wearable device including the set of haptic actuators.

28. The method of claim 27, further comprising:
calculating a distance from the centerline for a haptic actuator of the set of haptic actuators;
altering an amplitude of an audio signal to be transmitted to the haptic actuator based on the distance from the centerline; and
transmitting the altered audio signal to the haptic actuator.

29. The method of claim 21, wherein the first audio channel and the second audio channel are channels in a multi-channel audio signal, wherein the set of haptic actuators are a portion of all haptic actuators, wherein haptic actuators other than the set of haptic actuators are grouped with channels in the multi-channel audio signal other than the first audio channel and the second audio channel.

30. The method of claim 29, wherein the multi-channel audio signal has six channels.
